(19) United States
(12) Patent Application Publication
(10) Pub. No.: US 2026/0172720 A1
(43) Pub. Date: Jun. 18, 2026

(54) IMAGE SENSOR, ARRANGEMENT STRUCTURE, AND CONTROL METHOD

(71) Applicant: SMARTSENS TECHNOLOGY(HK) CO., LIMITED, HK (CN)

(72) Inventors: Shengxin ZHANG, Shanghai (CN); Wanqing WANG, Shanghai (CN)

(73) Assignee: SMARTSENS TECHNOLOGY(HK) CO., LIMITED, HK (CN)

(21) Appl. No.: 19/172,693

(22) Filed: Apr. 8, 2025

(30) Foreign Application Priority Data
Dec. 13, 2024 (CN) 2024118403246
Dec. 13, 2024 (CN) 2024230969719

(51) Int. Cl. H04N 25/78; H04N 25/77

(52) U.S. Cl. CPC H04N 25/78; H04N 25/77

(57) ABSTRACT

An image sensor, an arrangement structure and a control method are provided, wherein the image sensor comprises multiple pixel units arranged in an array, each of the pixel units includes: M photosensitive modules, wherein the M photosensitive modules are configured to convert optical signals into first and second charge signals, and to store the first charge signals and transfer the first charge signals to the floating diffusion node; M overflow modules, wherein the M overflow modules are configured to store the second charge signals; M transfer modules, wherein the M transfer modules are configured to transfer the second charge signals to the floating diffusion node; a reset module, wherein the reset module is configured to reset at least the floating diffusion node and the photosensitive modules; a readout module, wherein the readout module is configured to perform quantitative readout of the first charge signals and the second charge signals.

### CROSS REFERENCE TO RELATED APPLICATION

The present application claims the benefit of priority to Chinese Patent Application No. 2024118403246, entitled “Image Sensor, Arrangement Structure, and Control Method”, filed with CNIPA on Dec. 13, 2024, and also claims the benefit of priority to Chinese Patent Application No. 2024230969719, entitled “Image Sensor and Arrangement Structure”, filed with CNIPA on Dec. 13, 2024, the disclosures of which are incorporated herein by reference in their entirety for all purposes.

### FIELD OF TECHNOLOGY

The present disclosure relates to the technical field of image sensors, and in particular to an image sensor, an arrangement structure, and a control method.

### BACKGROUND

With the development of smartphones and other portable devices, the demand for photography and videography has placed higher performance requirements on image sensors. Among these requirements, higher resolution and higher signal-to-noise ratio are two important indicators. Generally, higher resolution and higher signal-to-noise ratio correspond to smaller pixel size and higher full well capacity in image sensors; physically, as the pixel size shrinks, the device size also shrinks, making it impossible to take into account the high full well capacity. Therefore, how to balance high resolution and high signal-to-noise ratio is a technical problem that those skilled in the art urgently want to solve.

It should be noted that the above description of the technical background is only for the convenience of a clear and complete explanation of the technical solution of the present disclosure and for the convenience of understanding by those skilled in the art. The above-described technical aspects cannot be considered to be well known to those skilled in the art merely because they are set forth in the background section of the present disclosure.

### SUMMARY

In view of the above-described shortcomings of the prior art, the present disclosure aims to provide an image sensor, an arrangement structure, and a control method for solving the problem that high resolution and high signal-to-noise ratio cannot be taken into account in the prior art.

To achieve the aforementioned objectives and other related purposes, the present disclosure provides an image sensor, which includes a plurality of pixel units arranged in an array. The pixel units include:
M photosensitive modules, coupled to a floating diffusion node, wherein the M photosensitive modules are configured to convert optical signals into first charge signals and second charge signals, and to store the first charge signals and transfer the first charge signals to the floating diffusion node;
M overflow modules, respectively coupled to the M photosensitive modules, wherein the M overflow modules are configured to store the second charge signals;
M transfer modules, coupled between the floating diffusion node and the M overflow modules, wherein the M transfer modules are configured to transfer the second charge signals to the floating diffusion node; wherein M is a natural number greater than or equal to 2;
a reset module, coupled to the floating diffusion node, wherein the reset module is configured to reset at least the floating diffusion node and the photosensitive modules;
a readout module, coupled to the floating diffusion node, wherein the readout module is configured to perform quantitative readout of the first charge signals and the second charge signals.

The present disclosure also provides an arrangement structure of the image sensor according to any of the above items, which includes:
a first area, wherein the photosensitive modules are arranged in the first area;
a second area defined in the first area, wherein the floating diffusion node is arranged in the second area;
wherein in each of the pixel units, the overflow modules and transfer modules are arranged in the first area and are arranged respectively around the photosensitive modules; for example, the overflow modules and transfer modules are arranged in pairs, and each pair includes one overflow module and one transfer module; each pair is arranged outside of and next to a corresponding one of the photosensitive modules;
wherein in each of the pixel units, the reset module and the readout module are arranged in the second area or arranged around the first area.

The present disclosure also provides a method for controlling the image sensor described above, which includes:
a reset stage, during which a reset operation is performed on the floating diffusion node, the photosensitive modules, and the overflow modules;
an exposure stage, during which the overflow modules are controlled to be turned on and the transfer modules are controlled to be turned off, wherein each of the photosensitive modules generates a first charge signal and a second charge signal based on photoelectric conversion, wherein the first charge signal is stored in each of the photosensitive modules, and the second charge signal is stored in each of the overflow modules;
a readout stage, during which the overflow modules are controlled to be turned off, thereby performing a quantitative readout of the first reset signal and the first charge signal based on the floating diffusion node;
performing quantitative readout of the second reset signal based on the floating diffusion node, and then controlling the transfer modules to turned on, transferring the second charge signal to the floating diffusion node for quantitative readout; and/or, controlling the transfer modules to turn on, transferring the second charge signal to the floating diffusion node for quantitative readout, and then performing a reset operation on the floating diffusion node for quantitative readout of the second reset signal.

The presently disclosed image sensor, arrangement structure, and control method of the present disclosure achieve a higher photosensitive area by sharing photosensitive elements. Through the lateral overflow technology, additional overflow capacitance is introduced to collect the overflow charge signals, enabling higher full well capacity to be achieved with smaller pixel sizes (e.g., <2 μm). This realizes a balance between high resolution and high signal-to-noise ratio.

### BRIEF DESCRIPTION OF THE DRAWINGS

FIG. 1 shows a schematic circuit diagram of a pixel unit in the image sensor illustrated in Embodiment 1 of the present disclosure.

FIG. 2 shows a schematic circuit diagram of a pixel unit in the image sensor illustrated in Embodiment 2 of the present disclosure.

FIG. 3 shows another schematic circuit diagram of a pixel unit in the image sensor illustrated in Embodiment 2 of the present disclosure.

FIG. 4 shows yet another schematic circuit diagram of a pixel unit in the image sensor illustrated in Embodiment 2 of the present disclosure.

FIG. 5 shows still another schematic circuit diagram of a pixel unit in the image sensor illustrated in Embodiment 2 of the present disclosure.

FIG. 6 shows a schematic circuit diagram of a pixel unit in the image sensor illustrated in Embodiment 3 of the present disclosure.

FIG. 7 shows another schematic circuit diagram of a pixel unit in the image sensor illustrated in Embodiment 3 of the present disclosure.

FIG. 8 shows yet another schematic circuit diagram of a pixel unit in the image sensor illustrated in Embodiment 3 of the present disclosure.

FIG. 9 shows a schematic circuit diagram of a pixel unit in the image sensor illustrated in Embodiment 4 of the present disclosure.

FIG. 10 shows another schematic circuit diagram of a pixel unit in the image sensor illustrated in Embodiment 4 of the present disclosure.

FIG. 11 shows yet another schematic circuit diagram of a pixel unit in the image sensor illustrated in Embodiment 4 of the present disclosure.

FIG. 12 shows a schematic diagram of an arrangement structure for the pixel units in the image sensor of the present disclosure.

FIG. 13 shows another schematic diagram of the arrangement structure for the pixel units in the image sensor of the present disclosure.

FIG. 14 shows a schematic diagram of the dynamic range of the image sensor in the present disclosure at a resolution of 50 MP.

### REFERENCE NUMERALS

100 Pixel units
110 Photosensitive modules
120 Overflow modules
130 Transfer modules
140 Reset module
150 Readout module
160 Gain module
170 Fast reset module
180 Shared transfer module

### DETAILED DESCRIPTION

The embodiments of the present disclosure will be described below. Those skilled can easily understand advantages and effects of the present disclosure according to contents disclosed by the specification. The present disclosure can also be implemented or applied through other different exemplary embodiments. Various modifications or changes can also be made to all details in the specification based on different points of view and applications without departing from the spirit of the present disclosure.

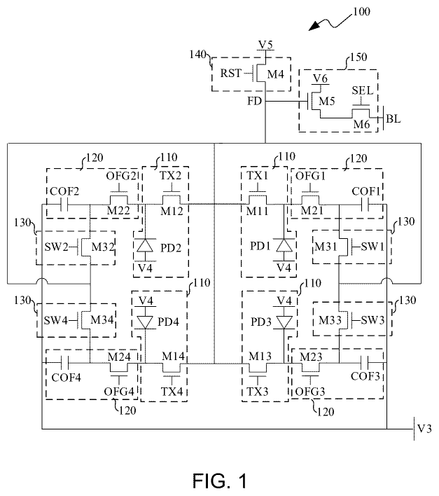

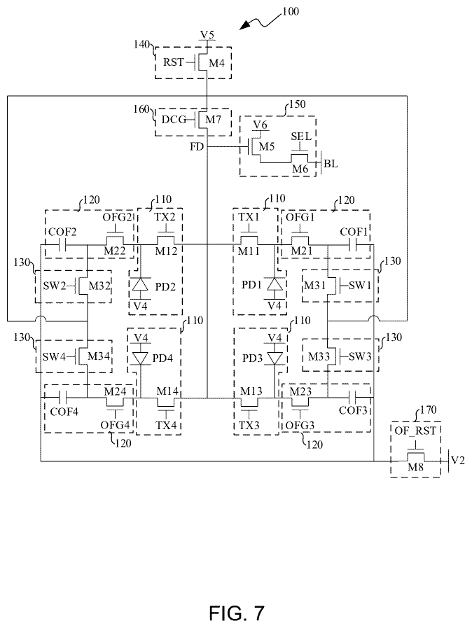

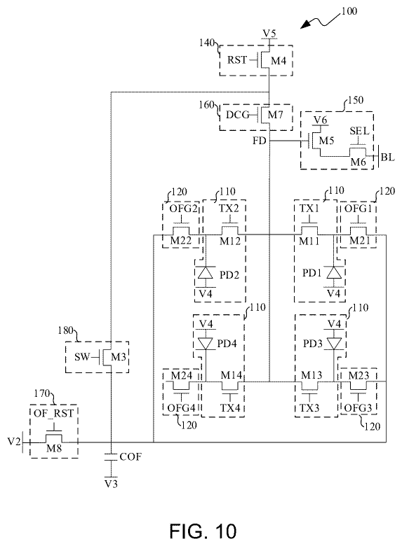

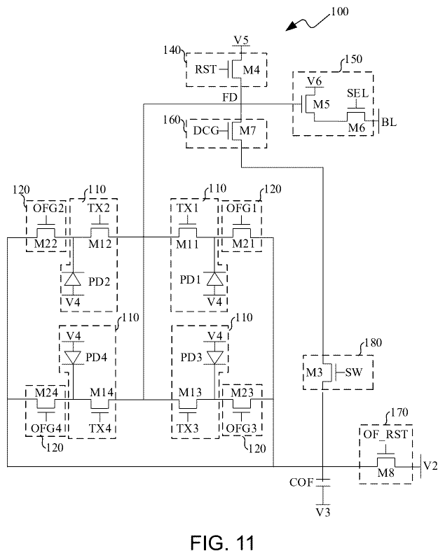

Refer to FIGS. 1 to 14. It should be noted that the drawings provided in this disclosure only illustrate the basic concept of the present disclosure in a schematic way, so the drawings only show the components closely related to the present disclosure. The drawings are not necessarily drawn according to the number, shape and size of the components in actual implementation; during the actual implementation, the type, quantity and proportion of each component can be changed as needed, and the components'layout may also be more complicated.

### Embodiment 1

As shown in FIG. 1, Embodiment 1 provides an image sensor including multiple of pixel units 100 arranged in an array; each of the pixel units 100 includes floating diffusion node FD, M photosensitive modules 110, M overflow modules 120, M transfer modules 130, a reset module 140, and a readout module 150. In this embodiment, M is a natural number equal to or greater than 2; in practical applications, M may be a natural number greater than or equal to 2 and less than or equal to 4; for example, M is equal to 4.

The M photosensitive modules 110 are coupled to the floating diffusion node FD, and are for converting an optical signal into a first charge signal and a second charge signal, and storing the first charge signal and transferring the first charge signal to the floating diffusion node FD. As an example, the circuit structure of each of the photosensitive modules 110 is the same, including a transmission transistor and a photosensitive element; a control terminal of the transmission transistor receives a transmission control signal, and a first terminal of the transmission transistor is coupled to the floating diffusion node FD. A second terminal of the transmission transistor is coupled to the fourth potential V4 through the photosensitive element, and the second terminal of the transmission transistor is also coupled to the corresponding overflow modules 120 in the implementation of this embodiment. In the present disclosure, in order to distinguish the photosensitive modules 110, different reference numerals are used to denote the transmission transistor, the photosensitive element, and the transmission control signal; taking M being 4 as an example, the transmission transistors are represented by M11 to M14, the photosensitive elements are represented by PD1 to PD4, and the transmission control signals are represented by TX1 to TX4, respectively.

In practice, the first charge signal may be a charge signal corresponding to the charge in the potential well, and the second charge signal may be a charge signal corresponding to the overflow charge; when the photosensitive modules 110 detect a charge amount that does not reach the overflow state, the converted charge signal only includes the first charge signal, which is stored in the photosensitive module 110. At this time, the second charge signal may be considered as zero; when the photosensitive modules 110 detect a charge amount that reaches the overflow state, the converted charge signal includes both the first charge signal and the second charge signal. The first charge signal is stored within the photosensitive module 110, while the second charge signal overflows beyond the photosensitive module 110 and is stored in the overflow module 120. Of course, in some other applications, it is also possible to define the first charge signal as a well charge signal and the second charge signal as an overflow charge signal.

The M overflow modules 120 are respectively coupled to the M photosensitive modules 110 for storing the second charge signal. As an example, the circuit structure of each of the overflow modules 120 is the same, including an overflow transistor and an overflow capacitor; a control terminal of the overflow transistor receives an overflow control signal; a first terminal of the overflow transistor is coupled to the corresponding photosensitive module 110, and a second terminal of the overflow transistor is coupled to the third potential V3 through the overflow capacitor. In the present disclosure, in order to distinguish the overflow modules 120, different reference numerals are used to denote the overflow transistor, the overflow capacitor, and the overflow control signal; taking M being 4 as an example, the overflow transistors are represented by M21 to M24, the overflow capacitors are represented by COF1 to COF4, and the overflow control signals are represented by OFG1 to OFG4.

The M transfer modules 130 are coupled between the floating diffusion node FD and the M overflow modules 120, and are for transferring the second charge signal to the floating diffusion node FD. As an example, the circuit structure of each of the transfer modules 130 is the same, including a transfer transistor; a control terminal of the transfer transistor receives the transfer control signal; a first terminal of the transfer transistor is coupled to the corresponding overflow module 120, and a second terminal of the transfer transistor is coupled to the floating diffusion node FD. In the present disclosure, in order to distinguish each of the transfer modules 130, different reference numerals are used to denote the transfer transistor and the transfer control signal; taking M being 4 as an example, the transfer transistors are denoted by M31 to M34, and the transfer control signals are denoted by SW1 to SW4, respectively.

The reset module 140 is coupled to the floating diffusion node FD, and are for resetting at least the floating diffusion node FD and the photosensitive modules 110; in this embodiment, the reset module 140 also resets the overflow modules 120. As an example, the reset module 140 includes a reset transistor M4; a control terminal of the reset transistor M4 receives a reset control signal RST; a first terminal of the reset transistor M4 is coupled to the fifth potential V5, and a second terminal of the reset transistor M4 is coupled to the floating diffusion node FD.

The readout module 150 is coupled to the floating diffusion node FD to perform quantitative readout of at least the first charge signal and the second charge signal. As an example, the readout module 150 includes a source follower transistor M5 and a select transistor M6; a control terminal of the source follower transistor M5 is coupled to the floating diffusion node FD; a first terminal of the source follower transistor M5 is coupled to the sixth potential V6, and a second terminal of the source follower transistor M5 is coupled to the first terminal of the selection transistor M6; a control terminal of the selection transistor M6 receives the selection control signal SEL, and a second terminal of the selection transistor M6 is coupled to the column line BL. In addition, the source follower transistor M5 and the select transistor M6 correspond one-to-one, and a number of the two transistors may be designed according to actual needs to perform signal readout correspondingly.

As an example, the transistors are NMOS transistors; as an example, the photosensitive element are photodiodes. In this case, each control terminal refers to a gate terminal, each first terminal refers to a drain terminal, and each second terminal refers to a source terminal. Of course, the transistors may also be PMOS transistors, and the photosensitive element may also be gratings or photoconductors. In addition, each potential should be designed according to actual needs; for example, the third potential V3 is usually a variable potential, the fourth potential V4 is usually a ground potential or a negative potential, the fifth potential V5 is usually a power supply potential, and the sixth potential V6 is usually a variable potential or a power supply potential.

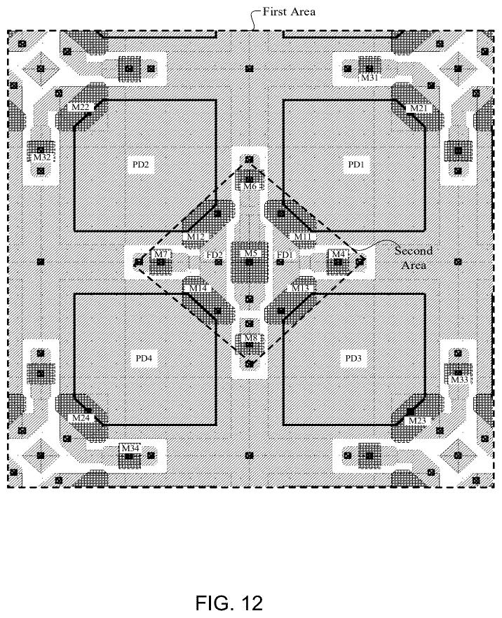

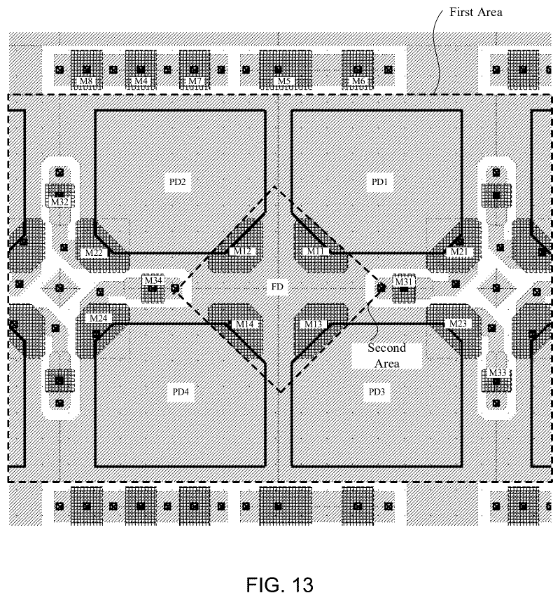

As shown in FIGS. 12 and 13, the present disclosure further provides an arrangement structure of an image sensor, wherein the image sensor is implemented by the structure described above, and the arrangement structure includes:
a first area is defined in each of the pixel units 100, and the photosensitive modules 110 are arranged in the first area;
a second area is defined in the first area, and the floating diffusion node FD is arranged in the second area;
in each of the pixel units, the overflow modules 120 and the transfer modules 130 are arranged in the first area, and are arranged respectively around the photosensitive modules 110;
in each of the pixel units, the reset module 140 and the readout module 150 are arranged in the second area or around the first area.

In one implementation, M is a natural number greater than or equal to 2 and less than or equal to 4, and in each of the pixel units, the photosensitive modules 110 are arranged in 2*1 or 2*2 arrays depending on a number of photosensitive modules 110 in the first area.

As an example, each of the photosensitive modules 110 includes a photosensitive element and a transmission transistor. Each transmission transistor is arranged in a first corner area facing a corresponding photosensitive element, and the photosensitive elements may be arranged in 2*1 or 2*2 arrays in the first area.

Specifically, when the number of photosensitive modules 110 is two, the photosensitive elements are arranged in a 2*1 array in the first area, that is, the two photosensitive elements are arranged in two adjacent rows of the same column; at this time, there are two groups of first corner areas where the two photosensitive elements face each other, and when the same column is defined as the first column, two transmission transistors are usually arranged on a group of first corner areas facing the second column. When the number of photosensitive modules 110 is three, the photosensitive elements are arranged in a 2*2 array in the first area, that is, the first photosensitive element and the second photosensitive element are arranged in two adjacent columns of the same row, the third photosensitive element and the first photosensitive element are arranged in two adjacent rows of the same column, or the third photosensitive element and the second photosensitive element are arranged in two adjacent rows of the same column. When the number of photosensitive modules 110 is four, the photosensitive elements are arranged in a 2*2 array in the first area, that is, the first photosensitive element and the second photosensitive element are arranged in two adjacent columns of the same row, the third photosensitive element and the first photosensitive element are arranged in two adjacent rows of the same column, and the fourth photosensitive element and the second photosensitive element are arranged in two adjacent rows of the same column, as shown in FIGS. 12 and 13.

A second area is defined based on the photosensitive modules 110 in the first area; specifically, the second area is defined based on the outer edge of each transmission transistor in the first area, as shown by a dotted line in the figure; at this time, the floating diffusion node FD is arranged in the second area. In practical application, the position of the floating diffusion node FD in the second area is related to the positions of the reset module 140 and the readout module 150; in an example, as shown in FIG. 12, if the reset module 140 and the readout module 150 are arranged in the second area, the floating diffusion node FD includes a first node area FD1 and a second node area FD2, which are symmetrically arranged between corresponding transmission transistors; taking M being 4 as an example, the first node area FD1 is arranged between the first transmission transistor M11 and the third transmission transistor M13, and the second node area FD2 is arranged between the second transmission transistor M12 and the fourth transmission transistor M14; in another example, as shown in FIG. 13, if the reset module 140 and the readout module 150 are arranged around the first area, the floating diffusion node FD is arranged in the entire second area. It should be noted that defining the second area based on the outer edge of each transmission transistor in the first area does not strictly involve an absolute boundary that precisely encompasses the outer edges; rather, it allows for relative expansion and contraction; and here, it is intended that the relative position of the second area including the floating diffusion node is defined by the contour of the outer edge of each transmission transistor.

The overflow modules 120 are arranged in the first area, and are arranged respectively around the photosensitive modules 110. As an example, each of the overflow modules 120 includes an overflow transistor, wherein each overflow transistor is arranged next to an edge or corner of each photosensitive element; further, each overflow transistor is arranged in any other corner area of the corresponding photosensitive element except the first corner area, so as to reduce the layout area. In one example, as shown in FIG. 12, each overflow transistor is arranged in a second corner area of the corresponding photosensitive element, wherein the second corner area and the first corner area are arranged opposite each other. In another example, each overflow transistor is arranged in a third corner area of the corresponding photosensitive element, wherein the third corner area and the first corner area are arranged along a first direction, as shown in FIG. 13, or the third corner area and the first corner area are arranged along a second direction; in practical applications, the first direction refers to a horizontal direction, and the second direction refers to a vertical direction. It should be noted that each of the overflow modules 120 further includes an overflow capacitor, but the overflow capacitor is arranged in another layer, for example, in a metal layer above the device layer, and is electrically connected to a corresponding transistor in the device layer by a conductor; however, the arrangement structure of this embodiment is mainly for transistors in the device layer, so the arrangement of capacitors such as overflow capacitors is not shown.

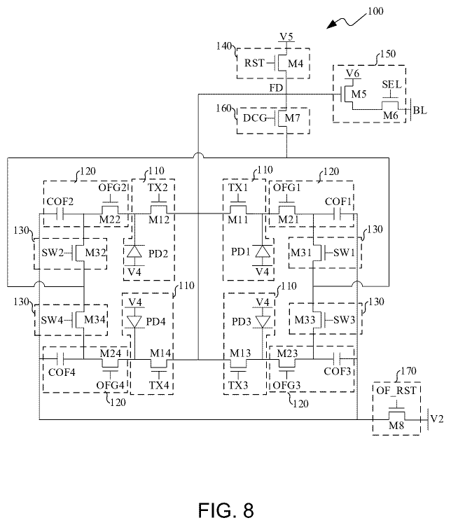

The transfer modules 130 are arranged in the first area and are arranged respectively around the photosensitive modules 110. As an example, each of the transfer modules 130 includes a transfer transistor, wherein each transfer transistor is arranged outside the corresponding photosensitive element; further, each transfer transistor is arranged adjacent to the corresponding overflow transistor, and each transfer transistor is arranged on an outer edge of the corresponding overflow transistor in a clockwise rotation manner, so as to minimize the area occupied by the photosensitive element and minimizing the loss of correlated double sampling full well capacity (CDSFWC). For example, as shown in FIG. 8, OFG1 to OFG4 correspond to the first to fourth overflow transistors, and SW1 to SW4 correspond to the first to fourth transfer transistors; as shown in FIG. 12, the positions of the second to fourth transfer transistors may be obtained by rotating the first transfer transistor clockwise in the first, third, fourth, and second order with reference to the respective overflow transistors; as shown in FIG. 13, taking each overflow transistor as an example, the positions of the second to fourth transfer transistors may be obtained by rotating the first transfer transistor clockwise in the first to fourth order.

The reset module 140 and the readout module 150 are arranged in the same area, wherein the same area is the second area or an area external to the first area. In practical application, the reset module 140 and the readout module 150 are arranged according to the position of each overflow transistor to reduce the layout area. In an example, as shown in FIG. 12, when each overflow transistor is arranged in the second corner area of the corresponding photosensitive element, the reset module 140 and the readout module 150 are arranged in the second area; as an example, the reset module 140 includes a reset transistor, and the readout module 150 includes a source follower transistor and a select transistor, wherein the source follower transistor is arranged between two node areas (a first node area and a second node area), the reset transistor is arranged outside either node area, for example, on the outer side of the second node area, and the select transistor is arranged outside the source follower transistor away from the node area, for example, on the upper side of the source follower transistor. In another example, as shown in FIG. 13, when each overflow transistor is arranged in the third corner area of the corresponding photosensitive element, the reset module 140 and the readout module 150 are arranged outside the first area relative to an edge or corner of the first corner area and the third corner area, and the arrangement direction of the reset module 140 and the readout module 150 is the same as the arrangement direction of the first corner area and the third corner area. For example, if the first corner area and the third corner area are arranged along the first direction, the reset module 140 and the readout module 150 are arranged on the outer upper side of the first area, and both are also aligned along the first direction. If the first corner area and the third corner area are arranged along the second direction, the reset module 140 and the readout module 150 are arranged on the outer left side of the first area, and both are also aligned along the second direction. As an example, the reset module 140 includes a reset transistor, and the readout module 150 includes a source follower transistor and a select transistor, wherein the source follower transistor is arranged corresponding to the floating diffusion node FD, for example, the centers of the source follower transistor and the floating diffusion node FD are on the same vertical line, or the centers of the source follower transistor and the select transistor are arranged on two sides of the source follower transistor, for example, the reset transistor is arranged on the left side of the source follower transistor and the select transistor is arranged on the right side of the source follower transistor.

The present disclosure also provides a control method of an image sensor, including a reset stage, an exposure stage, and a readout stage; the image sensor may be realized with the configuration described above.

In the reset stage, a reset operation is performed on the floating diffusion node FD, the photosensitive modules 110, and the overflow modules 120, and actually, the reset operation is performed on the floating diffusion node FD, the photosensitive modules 110, and the overflow modules 120 by the reset module 140.

For example, the reset transistor M4, each transmission transistor, and each transfer transistor are controlled to be turned on, and the charge of the floating diffusion node FD, each photosensitive element, and each overflow capacitor is cleared to complete the reset operation; thereafter, the reset transistor M4, each transmission transistor, and each transfer transistor are controlled to be turned off. As an alternative scheme, during the reset operation, each overflow transistor may be controlled to be turned on, which is beneficial to the execution of the reset operation of the overflow capacitors.

In the exposure stage, the overflow modules 120 are controlled to be turned on and the transfer modules 130 are controlled to be turned off, and each of the photosensitive modules 110 generates a first charge signal and a second charge signal based on photoelectric conversion, wherein the first charge signal is respectively stored in each photosensitive module 110, and the second charge signal is respectively stored in each overflow module 120.

For example, each overflow transistor is controlled to be turned on. If each overflow transistor has been turned on in the reset stage, it is not necessary to turn it on again in this stage; since each transfer transistor has been turned off in the reset stage, it is not necessary to turn off again in this stage. When the amount of charge sensed by each photosensitive element does not reach an overflow state, the converted charge signal includes only the first charge signal and is stored in each photosensitive element, and at this time, although each overflow transistor is turned on, no second charge signal is stored in each overflow capacitor through the corresponding overflow transistor, and the second charge signal may be considered to be zero. When the amount of charge sensed by each photosensitive element reaches an overflow state, the converted charge signal includes a first charge signal and a second charge signal, wherein the first charge signal is respectively stored on each photosensitive element, and the second charge signal is respectively stored in each overflow capacitor through the corresponding overflow transistor, but since each transfer transistor has been turned off, the overflow second charge signal does not affect the floating diffusion node. Finally, each overflow transistor is controlled to be turned off.

A readout stage including a correlation double sampling of the first charge signal, further including one or more of a correlation double sampling of the second charge signal and a non-true correlation double sampling of the second charge signal.

In one example, the readout stage includes a correlation double-sampling of the first charge signal and a correlation double-sampling of the second charge signal. Specifically, the overflow modules 120 are controlled to be turned off to perform quantitative readout of the first reset signal and the first charge signal based on the floating diffusion node FD, so as to realize correlated double sampling of the first charge signal. Quantitative readout of the second reset signal based on the floating diffusion node FD is performed, then the transfer modules 130 are controlled to be turned on, and the second charge signal is transferred to the floating diffusion node FD for quantitative readout, thus realizing correlation double sampling of the second charge signal; further, a reset operation is first performed on the floating diffusion node FD, and then quantitative readout of the second reset signal based on the floating diffusion node FD is performed.

For example, since each overflow transistor has been turned off in the exposure stage, it is not necessary to turn off again in the readout stage; first, the select transistor M6 is controlled to be turned on to perform quantitative readout of the first reset signal based on the floating diffusion node FD; then, the transmission transistors are controlled to be turned on and then off, transferring the first charge signal stored in each photosensitive element to the floating diffusion node FD and performing quantitative readout; thus, the correlated double sampling of the first charge signal is completed. First, the reset transistor M4 is controlled to be turned on and then off, performing a reset operation on the floating diffusion node FD, and performing quantitative readout of the second reset signal based on the floating diffusion node FD; then, the transfer transistors are controlled to be turned on and then off, transferring the second charge signal stored in each overflow capacitor to the floating diffusion node FD for quantitative readout; thus, the correlated double sampling of the second charge signal is completed.

In another example, the readout stage includes a correlation double-sampling of the first charge signal and a non-true correlation double-sampling of the second charge signal. Specifically, the overflow modules 120 are controlled to be turned off to perform quantitative readout of the first reset signal and the first charge signal based on the floating diffusion node FD, so as to realize correlated double sampling of the first charge signal. The transfer modules 130 are controlled to turn on, transferring the second charge signal to the floating diffusion node FD for quantitative readout, and then a reset operation is performed on the floating diffusion node FD for quantitative readout of the second reset signal, thereby realizing non-true correlated double sampling of the second charge signal.

For example, first the transfer transistors are controlled to be turned on and then off, transferring the second charge signal stored in each overflow capacitor to the floating diffusion node FD, and performing quantitative readout; then the reset transistor M4 is controlled to be turned on and then off, performing a reset operation on the floating diffusion node FD, and performing quantitative readout of the second reset signal based on the floating diffusion node FD; thus, non-true correlation double sampling of the second charge signal is accomplished. It should be noted that the method of performing correlated double sampling on the first charge signal is the same as that of the previous example.

In yet another example, the readout stage includes correlation double sampling of the first charge signal, correlation double sampling of the second charge signal, and non-true correlation double sampling of the second charge signal. It should be noted that the methods of performing correlated double sampling on the first charge signal, correlated double sampling on the second charge signal, and non-true correlated double sampling on the second charge signal are the same as those of the above-described examples.

In one example, the method for reading out the second charge signal in each of the overflow modules 120 includes either reading out by merging the second charge signals from two or more overflow modules 120, or reading out the second charge signals from each of the overflow modules 120 separately. For example, in the example shown in FIG. 1, in one implementation, the transfer modules 130 corresponding to the four overflow modules may be turned on simultaneously, so that the second charge signals in the four overflow modules are read out in a merged manner. At this time, for correlated double sampling and non-true correlated double sampling of the merged signal, the same number of second reset signals as the merged second charge signals may be output. When the four overflow modules are merged, one corresponding second reset signal of the merged signal may be output. Another implementation method may be that the second charge signals in the four overflow modules are read out separately, such as sequentially read out in the order of the first to fourth overflow modules, wherein the correlation double sampling process corresponding to the second charge signal may be that each of the overflow modules sequentially reads out a second reset signal and a corresponding second charge signal, and the correlation double sampling process corresponding to the second charge signal may be that each of the overflow modules sequentially reads out a second charge signal and a corresponding second reset signal; of course, in other examples, the signal and sequence of readout may be selected according to actual conditions.

### Embodiment 2

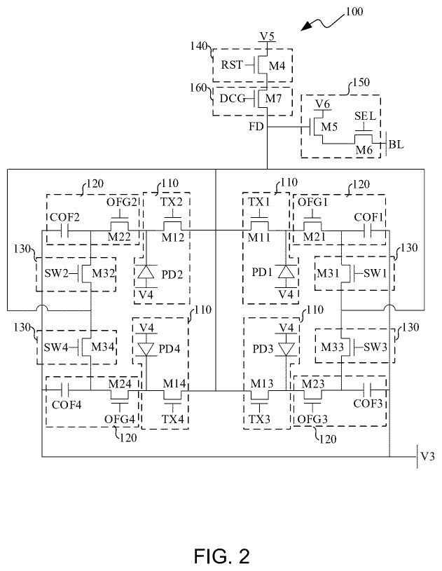

As shown in FIGS. 2 to 5, Embodiment 2 provides an image sensor, which differs from Embodiment 1 in that each of the pixel units 100 in this embodiment further includes a gain module 160 for switching between different conversion gains.

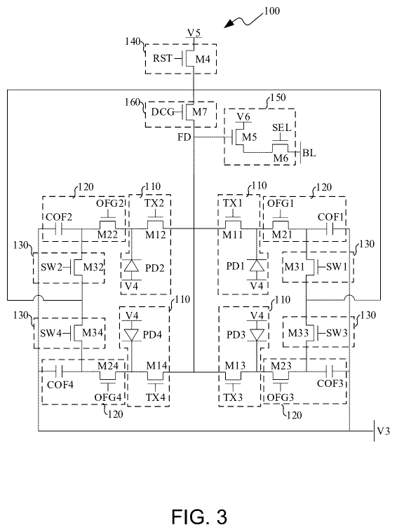

In one example, as shown in FIGS. 2 and 3, the gain module 160 is coupled between the reset module 140 and the floating diffusion node FD, and at this time, the second terminal of the reset transistor M4 in the reset module 140 is changed from being coupled to the floating diffusion node FD to being coupled to the gain module 160. As an example, the gain module 160 includes a gain transistor M7; a control terminal of the gain transistor M7 receives a gain control signal DCG, and a first terminal of the gain transistor M7 is coupled to the reset module 140, for example, a second terminal of the reset transistor M4, and a second terminal of the gain transistor M7 is coupled to the floating diffusion node FD. In this example, the gain module 160 also includes a gain node, wherein the gain node is formed at the first terminal of the gain transistor M7, that is, the first terminal of the gain transistor M7 is configured as the gain node. Specifically, the gain node corresponds to the parasitic capacitance of the transistor, and of course, in other implementations, a device capacitance may be prepared corresponding to the point as the capacitance capacity of the gain node.

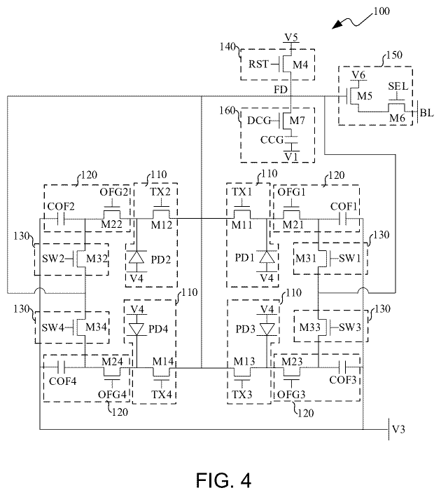

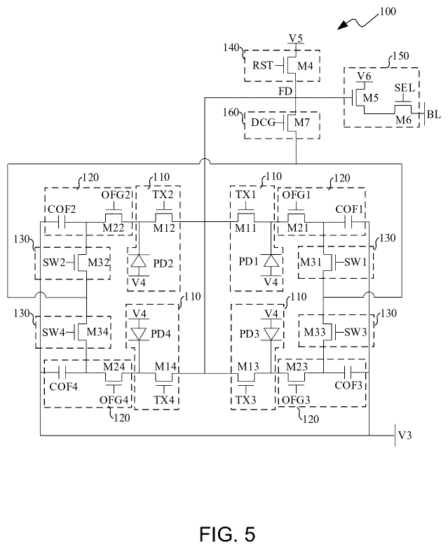

In another example, as shown in FIGS. 4 and 5, the gain module 160 is coupled to the floating diffusion node FD. In one implementation, the gain module 170 includes a gain transistor M7 and a gain capacitor CCG; a control terminal of the gain transistor M7 receives the gain control signal DCG; a first terminal of the gain transistor M7 is coupled to the floating diffusion node FD, and a second terminal of the gain transistor M7 is coupled to the first potential V1 through the gain capacitor CCG. In this example, the gain module 160 also includes a gain node, wherein the gain node is formed at the second terminal of the gain transistor M7, that is, the second terminal of the gain transistor M7 is used as the gain node. The gain capacitance CCG may be a device capacitance configured corresponding to the node, or, of course, it may also be a parasitic capacitance of the node.

In practical applications, the gain node replaces the floating diffusion node FD for electrical connection, so that one or more of the M transfer modules 130 is coupled between the gain node and the corresponding overflow module 120, and at this time, the second terminal of the transfer transistor in the corresponding transfer module 130 is changed from being coupled to the floating diffusion node FD to being coupled to the gain node. That is, the M transfer modules 130 may all be coupled between the floating diffusion node FD and the M overflow modules 120 (as shown in FIGS. 2 and 4), may all be coupled between the gain node and the M overflow modules 120 (as shown in FIGS. 3 and 5), may also be coupled in part between the floating diffusion node FD and the corresponding overflow module 120, and the other part may be coupled between the gain node and the corresponding overflow module 120; however, for the sake of storage capacity and control mode, the M transfer modules 130 are generally all coupled between the gain node and the M overflow modules 120. For the example in which the gain module 160 is coupled to the floating diffusion node FD, the external gain capacitor CCG may be omitted, as shown in FIG. 5. Of course, not omitting it is also feasible, which has no substantial impact on the implementation of the scheme.

As an example, the gain transistor M7 is NMOS transistor; in this case, each control terminal refers to a gate terminal, each first terminal refers to a drain terminal, and each second terminal refers to a source terminal; of course, the gain transistor M7 may also be a PMOS transistor. In addition, the first potential V1 is usually a variable potential.

As an example, when each of the pixel units 100 includes the gain module 160, the gain modules of two or more pixel units have a connection structure to realize sharing between the connected gain modules based on the connection structure; the gain modules 160 of two adjacent rows of pixel units in the same column may be connected by a connection structure. Taking the structure shown in FIG. 3 as an example, the drain terminals of the two gain modules may be connected, so that when signal readout is performed on one row of pixels, the low-gain node (corresponding to the drain of the gain module of the other row) of the gain module of the other row of pixel units may be utilized. At this time, in one implementation, the gain transistor DCG of the other shared pixel unit may be in an off state. The number and position of the pixel units of the shared gain module may be selected according to the actual demand, and the connection structure may be a metal interconnection line, which is manufactured in the metal layer. Of course, one or more switch transistors may be provided on the path of the shared connection to control the path.

As shown in FIGS. 12 and 13, Embodiment 2 also provides an arrangement structure of image sensors, which is different from Embodiment 1 in that the gain module 160 is provided. In this embodiment, the gain module 160 is arranged in the same area as the reset module 140 and the readout module 150. As an example, the gain module 160 includes gain transistor M7. In an example, as shown in FIG. 12, when the same area is the second area, the gain transistor M7 and the reset transistor M4 are symmetrically arranged, for example, the reset transistor M4 is arranged outside the first node area FD1, and the gain transistor M7 is arranged outside the second node area FD2. In another example, as shown in FIG. 13, when the same area is an area external to the first area, the gain transistor M7 is disposed between the reset transistor M4 and the source follower transistor M5.

Embodiment 2 also provides a method for controlling an image sensor, which is different from the method of Embodiment 1 in the reset stage and the readout stage.

In the reset stage, the gain module 160 is also reset, in addition to the reset operation of the floating diffusion node FD, the photosensitive modules 110, and the overflow modules 120. For example, when the reset operation is performed, the gain transistor M7 is also controlled to be turned on to facilitate the reset operation.

In the readout stage, regarding the first charge signal: correlated double sampling is performed on the first charge signal under different conversion gains. Specifically, the gain module 160 is controlled to be turned on and then off to perform quantitative readout of the first reset signal under different conversion gains based on the floating diffusion node FD, and the gain module 160 is controlled to be turned off and then on to perform quantitative readout of the first charge signal under different conversion gains based on the floating diffusion node FD. For example, since the gain transistor M7 has been turned on in the reset stage, the image sensor operates at a low conversion gain and performs quantitative readout of the first reset signal at low conversion gain based on the floating diffusion node FD; then the gain transistor M7 is controlled to be turned off, switching the image sensor to high conversion gain, and performing quantitative readout of the first reset signal at high conversion gain based on the floating diffusion node FD; then the transmission transistors are controlled to be turned on and then off, transferring the first charge signal stored in each photosensitive element to the floating diffusion node FD, and performing quantitative readout of the first charge signal at high conversion gain based on the floating diffusion node FD; then the gain transistor M7 is controlled to be turned on, switching the image sensor back to low conversion gain, and performing quantitative readout of the first charge signal at low conversion gain based on the floating diffusion node FD; thus, correlated double sampling of the first charge signal at different conversion gains is accomplished.

Regarding the second charge signal: in the case where the conversion gain 160 is coupled between the reset module 140 and the floating diffusion node FD, the gain transistor M7 is controlled to be turned on when performing quantitative readout of the second charge signal, and the gain transistor M7 is also controlled to be turned on during the corresponding readout of the second reset signal. In the case where the conversion gain 160 is coupled to the floating diffusion node FD, the gain transistor M7 may be controlled to be turned on or off when performing quantitative readout of the second charge signal, but usually, the gain transistor M7 is controlled to be turned on. In addition, during the corresponding readout of the second reset signal, the operation of the gain transistor M7 is the same as that during the readout of the second charge signal, i.e., the second reset signal and the second charge signal are read out simultaneously when the gain transistor M7 is turned on, or when the gain transistor M7 is turned off.

### Embodiment 3

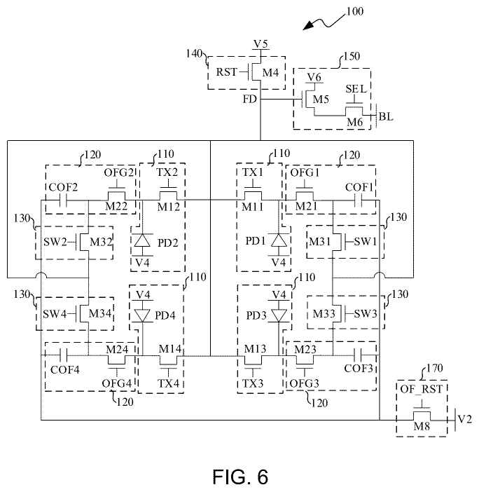

As shown in FIGS. 6 to 8, Embodiment 3 provides an image sensor, which differs from Embodiment 1 or Embodiment 2 in that: each of the pixel units 100 includes a fast reset module 170 coupled to M overflow modules 120, and the fast reset module 170 is configured to perform fast reset on the overflow modules 120. At this time, the second terminal of the overflow transistor in the M overflow modules 120 is changed from being coupled to the third potential V3 to being coupled to the fast reset module 170 through the overflow capacitor. As an example, the fast reset module 170 includes a fast reset transistor M8; the control terminal of the fast reset transistor M8 receives the fast reset signal OF_RST, the first terminal of the fast reset transistor M8 is coupled to the second potential V2, and the second terminal of the fast reset transistor M8 is coupled to each of the overflow modules 120, for example, coupled to an end of the overflow capacitor in each of the overflow modules 120 that is away from the overflow transistor.

As an example, the fast reset transistor M8 is NMOS transistor; in this case, each control terminal refers to a gate terminal, each first terminal refers to a drain terminal, and each second terminal refers to a source terminal; of course, the fast reset transistor M8 may also be a PMOS transistor. In addition, the second potential V2 is equal to the fifth potential V5, and is usually a power supply potential.

As shown in FIGS. 12 and 13, this embodiment also provides an arrangement structure of image sensors, which differs from Embodiment 1 or Embodiment 2 in that: the fast reset module 170 is provided. In this embodiment, the fast reset module 170, the reset module 140, and the readout module 150 are arranged in the same area; in one implementation, the fast reset module 170 includes a fast reset transistor M8. In one example, as shown in FIG. 12, when the same area is the second area, the fast reset transistor M8 and the select transistor M6 are symmetrically arranged, for example, the select transistor M6 is arranged above the source follower transistor M5 and the fast reset transistor M8 is arranged below the source follower transistor M5. In another example, as shown in FIG. 13, when the same area is an area external to the first area, the fast reset transistor M8 is arranged outside the reset transistor M4.

Embodiment 3 also provides a method for controlling an image sensor, which differs from Embodiment 1 or Embodiment 2 in the reset stage. In one example, the difference from Embodiment 1 or Embodiment 2 may also be in the readout stage.

In the reset stage, at least the overflow modules 120 are reset by the fast reset module 170. In one example, the overflow modules 120 are reset jointly by the reset module 140 and the fast reset module 170; for example, when the reset operation is performed, the fast reset transistor M 8 is also controlled to be turned on, the charge of each overflow capacitor is cleared to complete the reset operation, and then the fast reset transistor and each transfer transistor are controlled to be turned off. In another example, the reset operation is performed on the overflow modules 120 only by the fast reset module 170; for example, when the reset operation is performed, the fast reset transistor M8 is controlled to be turned on, at which time, the transfer transistor and/or the overflow transistor is no longer turned on, and the charge of the overflow capacitor is cleared to complete the reset operation, and then the fast reset transistor is controlled to be turned off.

In one example, during the readout stage, in the case of non-true correlated sampling readout of the second charge signal, after the readout of the second charge signal, a reset operation is performed on the floating diffusion node to perform quantitative readout of the second reset signal. At this time, during this reset operation, the fast reset module may be further turned on to perform fast reset on the overflow modules.

### Embodiment 4

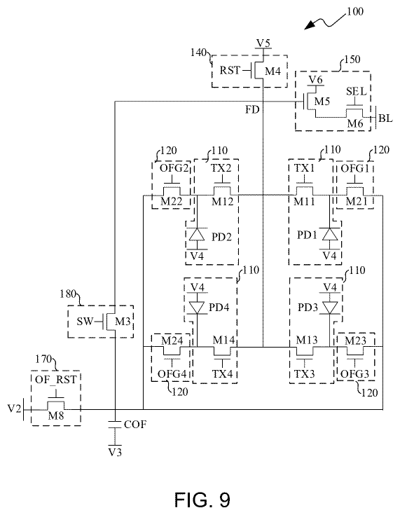

As shown in FIGS. 9 to 11, Embodiment 4 provides an image sensor, which is different from Embodiment 1, Embodiment 2, or Embodiment 3 in that when two or more overflow capacitors in each of the pixel units 100 are coupled to the same node (floating diffusion node FD and/or gain node) through the corresponding transfer module 130, the corresponding overflow capacitance may be replaced by the common overflow capacitance COF, and at this time, the second end of the corresponding overflow transistor is coupled to the third potential V3 through the common overflow capacitance COF, thereby realizing the sharing of the overflow capacitance by the corresponding overflow module 120.

For the case of shared overflow capacitance, the corresponding transfer modules 130 should also be replaced by the shared transfer module 180 to transfer the second charge signal stored in the common overflow capacitance COF to the corresponding node by the shared transfer module 180. as an example, the shared transfer module 180 includes a shared transfer transistor M3; a control terminal of the shared transfer transistor M3 receives a co-shift control signal SW; a first terminal of the shared transfer transistor M3 is coupled to an end of the co-shift capacitor COF away from the third potential V3, and a second terminal of the shared transfer transistor M3 is coupled to the corresponding node.

In practical application, each overflow capacitor is usually coupled to the same node, i.e., the floating diffusion node FD or the gain node, through a corresponding one of the transfer modules 130. At this time, each overflow capacitor is replaced by a common overflow capacitor COF, and the second terminal of each overflow transistor is coupled to the third potential V3 through the common overflow capacitor COF, thereby realizing the sharing of the overflow capacitors in the overflow modules 120. At the same time, the transfer modules 130 are also replaced by the shared transfer module 180; the shared transfer module 180 includes the shared transfer transistor M3, whose control terminal receives the co-shift control signal SW, whose first terminal is coupled to the end of the co-shift capacitor COF away from the third potential V3, and whose second terminal is coupled to the floating diffusion node FD or the gain node.

Embodiment 4 also provides an arrangement structure of image sensors, which differs from Embodiment 1, Embodiment 2, or Embodiment 3 in that: the shared transfer module 180 is provided; in this embodiment, two or more transfer modules 130 are replaced by the shared transfer module 180. In one implementation, the shared transfer module 180 includes the shared transfer transistor M3, wherein the shared transfer transistor M3 is arranged at a location of any transfer transistor that has been replaced. In practical applications, all the transfer modules 130 are usually replaced by a shared transfer module 180, and at this time, the shared transfer transistor M3 may be arranged at a location of any transfer transistor.

Embodiment 4 also provides a method for controlling an image sensor, which is the same as the method of Embodiment 1, Embodiment 2, or Embodiment 3, and will not be repeatedly described here.

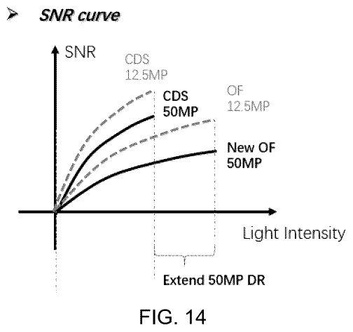

In the image sensors of the above-described embodiments of the present disclosure, the overflow modules 120 and the transfer modules 130 are mainly for expanding the dynamic range. When performing a shared design for the photosensitive modules 110, the original potential design may still be retained. The design of the present disclosure brings more improvement to the performance of small-size pixels, and makes it easier to realize high resolution and high signal-to-noise ratio; taking a 50 MP image sensor as an example, the dynamic range at a resolution of 50 MP is expanded by the present disclosure, as shown in FIG. 14. Of course, in the case of signal combination, such as at a resolution of 12.5 MP, the present disclosure may also expand the dynamic range.

As described above, the image sensor, arrangement structure, and control method of the present disclosure achieve a higher photosensitive area by sharing photosensitive elements. Through the lateral overflow technology, additional overflow capacitance is introduced to collect the overflow charge signals, enabling higher full well capacity to be achieved with smaller pixel sizes (e.g., <2 μm). This realizes a balance between high resolution and high signal-to-noise ratio. Therefore, the present disclosure effectively overcomes various shortcomings in the existing technology and has high industrial utilization value.

The above-mentioned embodiments are merely illustrative of the principle and effects of the present disclosure instead of restricting the scope of the present disclosure. Any person skilled in the art may modify or change the above embodiments without violating the principle of the present disclosure. Therefore, all equivalent modifications or changes made by those who have common knowledge in the art without departing from the spirit and technical concept disclosed by the present disclosure shall still be covered by the claims of the present disclosure.

What is claimed is:

1. An image sensor, comprising multiple pixel units arranged in an array, wherein each of the pixel units comprises:
M photosensitive modules, coupled to a floating diffusion node, wherein the M photosensitive modules are configured to convert optical signals into first charge signals and second charge signals, and to store the first charge signals and transfer the first charge signals to the floating diffusion node;
M overflow modules, respectively coupled to the M photosensitive modules, wherein the M overflow modules are configured to store the second charge signals;
M transfer modules, coupled between the floating diffusion node and the M overflow modules, wherein the M transfer modules are configured to transfer the second charge signals to the floating diffusion node; wherein M is a natural number greater than or equal to 2;
a reset module, coupled to the floating diffusion node, wherein the reset module is configured to reset at least the floating diffusion node and the photosensitive modules;
a readout module, coupled to the floating diffusion node, wherein the readout module is configured to perform quantitative readout of the first charge signals and the second charge signals;

2. The image sensor according to claim 1, wherein each of the pixel units further comprises:
a gain module, wherein the gain module is coupled between the reset module and the floating diffusion node, or coupled to the floating diffusion node, wherein the gain module is configured to switch between different conversion gains;
and/or, a fast reset module, coupled to the M overflow modules, wherein the fast reset module is configured to fast reset the overflow modules.

3. The image sensor according to claim 2, wherein each of the pixel units comprises the gain module and the gain module is coupled between the reset module and the floating diffusion node, wherein the gain module comprises a gain transistor, wherein a control terminal of the gain transistor receives a gain control signal, wherein a first terminal of the gain transistor is coupled to the reset module, and a second terminal of the gain transistor is coupled to the floating diffusion node; wherein each of the pixel units comprises the gain module and the gain module is coupled to the floating diffusion node, and the gain module comprises the gain transistor and a gain capacitor, wherein a control terminal of the gain transistor receives a gain control signal, wherein a first terminal of the gain transistor is coupled to the floating diffusion node, and a second terminal of the gain transistor is coupled to a first potential through the gain capacitor; wherein each of the pixel units comprises the fast reset module, and the fast reset module comprises a fast reset transistor, wherein a control terminal of the fast reset transistor receives a fast reset signal, wherein a first terminal of the fast reset transistor is coupled to a second potential, and a second terminal of the fast reset transistor is coupled to each of the overflow modules;
and/or, wherein each of the pixel units comprises the gain module, and there is a connection structure between gain modules of two or more pixel units, to realize sharing among the gain modules based on the connection structure.

4. The image sensor according to claim 3, wherein each of the pixel units comprises the gain module, and the gain module further comprises a gain node, wherein one or more of the M transfer modules are coupled between the gain node and the corresponding overflow module; wherein the gain module is coupled between the reset module and the floating diffusion node, and the first terminal of the gain transistor acts as a gain node; or wherein the gain module is coupled to the floating diffusion node, and the second terminal of the gain transistor acts as a gain node.

5. The image sensor according to claim 1, wherein each of the overflow modules comprises an overflow transistor and an overflow capacitor, wherein a control terminal of the overflow transistor receives an overflow control signal, wherein a first terminal of the overflow transistor is coupled to a corresponding photosensitive module, and a second terminal of the overflow transistor is coupled to a third potential through the overflow capacitor; wherein each of the pixel units comprises the fast reset module, and the second terminal of the overflow transistor is changed from being coupled to the third potential to being coupled to the fast reset module through the overflow capacitor;
and/or, the transfer module comprises a transfer transistor, wherein a control terminal of the transfer transistor receives a transfer control signal, wherein a first terminal of the transfer transistor is coupled to a corresponding overflow module, and a second terminal of the transfer transistor is coupled to the floating diffusion node; wherein one or more of the M transfer modules are coupled between the gain node and the corresponding overflow module, and the second terminal of the transfer transistor in the corresponding transfer module is changed from being coupled to the floating diffusion node to being coupled to the gain node.

6. The image sensor according to claim 5, wherein each of the overflow modules comprises the overflow transistor and the overflow capacitor, and two or more overflow capacitors are coupled to the same node through corresponding transfer modules, wherein corresponding overflow capacitors are replaced by a shared overflow capacitor, and a second terminal of the corresponding overflow transistor is coupled to a third potential through the shared overflow capacitor; corresponding transfer modules are replaced by a shared transfer module, wherein the shared transfer module comprises a shared transistor, wherein a control terminal of the shared transistor receives a common shift control signal, wherein a first terminal of the shared transistor is coupled to a corresponding shared overflow capacitor, and a second terminal of the shared transistor is coupled to a corresponding node.

7. The image sensor according to claim 1, wherein each of the photosensitive modules comprises a transmission transistor and a photosensitive element, wherein a control terminal of the transmission transistor receives a transmission control signal, wherein a first terminal of the transmission transistor is coupled to the floating diffusion node, and a second terminal of the transmission transistor is coupled to a fourth potential through the photosensitive element and is coupled to a corresponding overflow module;
and/or, the reset module comprises a reset transistor, wherein a control terminal of the reset transistor receives a reset control signal, wherein a first terminal the reset transistor is coupled to a fifth potential, and a second terminal of the reset transistor is coupled to the floating diffusion node; wherein each of the pixel units comprises the gain module, and the gain module is coupled between the reset module and the floating diffusion node, wherein the second terminal of the reset transistor is coupled to the gain module;
and/or, the readout module comprises a source follower transistor and a selection transistor, wherein a control terminal of the source follower transistor is coupled to the floating diffusion node, wherein a first terminal of the source follower transistor is coupled to a sixth potential, and a second terminal of the source follower transistor is coupled to the first terminal of the selection transistor, wherein the control terminal receives a select control signal, and the second terminal is coupled to a column line.

8. An arrangement structure of an image sensor according to claim 1, wherein each of the pixels units comprises:
a first area, wherein the photosensitive modules are arranged in the first area;
a second area defined in the first area, wherein the floating diffusion node is arranged in the second area;
wherein in each of the pixel units, the overflow modules and transfer modules are arranged in the first area and are arranged respectively around the photosensitive modules;
wherein in each of the pixel units, the reset module and the readout module are arranged in the second area or arranged around the first area.

9. The arrangement structure of the image sensor according to claim 8, wherein in each of the pixel units, the photosensitive modules are arranged in 2*1 or 2*2 arrays depending on a number of the photosensitive modules in the first area, wherein M is a natural number greater than or equal to 2 and less than or equal to 4;
wherein the second area is defined in the first area based on the photosensitive modules.

10. The arrangement structure of the image sensor according to claim 8, wherein each of the photosensitive modules comprises the photosensitive element and the transmission transistor, wherein the transmission transistor is arranged in a first corner area of the corresponding photosensitive element;
wherein the second area is defined based on an outer edge of each transmission transistor; and/or, each of the overflow modules comprises the overflow transistor, wherein the overflow transistor is arranged next to an edge or corner of the corresponding photosensitive element; and/or, each of the transfer modules comprises the transfer transistor, wherein the transfer transistor is arranged on the outside of the corresponding photosensitive element.

11. The arrangement structure of the image sensor according to claim 10, wherein each of the transfer modules comprises the transfer transistor, wherein each transfer transistor is arranged adjacent to the corresponding overflow transistor, and each transfer transistor is arranged on an outer edge of each overflow transistor in a clockwise rotation manner.

12. The arrangement structure of the image sensor according to claim 11, wherein corresponding transfer modules are replaced by a shared transfer module, the shared transfer module comprises shared transfer transistor arranged at any of positions of replaced transfer transistor.

13. The arrangement structure of the image sensor according to claim 10, wherein each overflow transistor is arranged in a second corner area of the corresponding photosensitive element, wherein the second corner area is arranged opposite to the first corner area; or, each overflow transistor is arranged in a third corner area of the corresponding photosensitive element, wherein the third corner area is arranged along a first direction or a second direction opposite the first corner area.

14. The arrangement structure of the image sensor according to claim 13, wherein each overflow transistor is arranged in the second corner area of the corresponding photosensitive element, wherein the reset module and the readout module are arranged in the second area;
wherein each overflow transistor is arranged in the third corner area of the corresponding photosensitive element, the reset module and the readout module are arranged outside the first area relative to an edge or corner of the first corner area and the third corner area, wherein an arrangement direction of the reset module and the readout module is parallel to an arrangement direction of the first corner area and the third corner area.

15. The arrangement structure of the image sensor according to claim 8, wherein the reset module comprises a reset transistor, and the readout module comprises a source follower transistor and a selection transistor;
the reset module and the readout module are arranged in the second area, wherein the floating diffusion node comprises a first node area and a second node area, wherein the first node area and the second node area are both symmetrically arranged between the corresponding transmission transistors, the source follower transistor is arranged between two node areas, the reset transistor is arranged outside any node area, and the selection transistor is arranged outside the source follower transistor remote from node areas;
the reset module and the readout module are arranged outside the first area relative to an edge or corner of the first corner area and the third corner area, wherein the source follower transistor is arranged corresponding to the floating diffusion node, and the reset transistor and the selection transistor are arranged on both sides of the source follower transistor.

16. The arrangement structure of the image sensor according to claim 8, wherein each of the pixel units further comprises a gain module and/or a fast reset module, wherein the gain module and/or the fast reset module are arranged in the same area as the reset module and the readout module; wherein the gain module comprises a gain transistor, and the fast reset module comprises a fast reset transistor.

17. The arrangement structure of the image sensor according to claim 16, wherein the same area is the second area, wherein the gain transistor in the gain module and the reset transistor in the reset module are symmetrically arranged, and the fast reset transistor in the fast reset module and the selection transistor in the readout module are symmetrically arranged; or
the same area is an area external to the first area, wherein the gain transistor in the gain module is arranged between the reset transistor in the reset module and the source follower transistor in the readout module, and the fast reset transistor in the fast reset module is arranged outside the reset transistor in the reset module.

18. A control method of the image sensor according to claim 1, comprising:
a reset stage, during which a reset operation is performed on the floating diffusion node, the photosensitive modules, and the overflow modules;
an exposure stage, during which the overflow modules are controlled to be turned on and the transfer modules are controlled to be turned off, wherein each of the photosensitive modules generates a first charge signal and a second charge signal based on photoelectric conversion, wherein the first charge signal is stored in each of the photosensitive modules, and the second charge signal is stored in each of the overflow modules;
a readout stage, during which the overflow modules are controlled to be turned off, thereby performing a quantitative readout of the first reset signal and the first charge signal based on the floating diffusion node;
quantizing the readout of the second reset signal based on the floating diffusion node, and then controlling the transfer modules to turned on, transferring the second charge signal to the floating diffusion node for quantitative readout; and/or, controlling the transfer modules to turn on, transferring the second charge signal to the floating diffusion node for quantization readout, and then performing a reset operation on the floating diffusion node for quantitative readout of the second reset signal.

19. The control method of the image sensor according to claim 18, wherein during the readout stage, the second reset signal is quantized and read out before the second charge signal, the floating diffusion node is reset first, and then the second reset signal is quantized and read out based on the floating diffusion node; and/or, a method for reading out the second charge signals in the overflow modules comprises: reading out in a manner that combines two or more second charge signals in the overflow modules, or reading out the second charge signal in each of the overflow modules separately.

20. The control method of the image sensor according to claim 18, wherein each of the pixel units comprises the gain module, wherein a method for performing quantitative readout of the first reset signal and the first charge signal based on the floating diffusion node comprises: controlling the gain module to turn on and then turn off to perform quantitative readout of the first reset signal at different conversion gains based on the floating diffusion node, and then controlling the gain module to turn off and then turn on, quantizing and reading out the first charge signal at different conversion gains based on the floating diffusion node;
and/or, each of the pixel units comprises the gain module, wherein a method for performing quantitative readout of the second reset signal and the second charge signal based on the floating diffusion node comprises: wherein the gain module is coupled between the reset module and the floating diffusion node, controlling the gain module to turn on during quantitative readout of both the second reset signal and the second charge signal; wherein the gain module is coupled to the floating diffusion node, controlling the corresponding gain module to turn on or turn off during quantitative readout of both the second reset signal and the second charge signal;
and/or, each of the pixel units comprises a fast reset module, performing a reset operation on the overflow modules through the fast reset module at least during the reset stage and/or during the readout stage of the second charge signal in a non-true correlated double sampling readout manner.
